(19) United States
(12) Patent Application Publication
(10) Pub. No.: US 2020/0271974 A1
(43) Pub. Date: Aug. 27, 2020

(54) DISPLAY DEVICE

(71) Applicants: HKC Corporation Limited, Shenzhen (CN); Chongqing HKC Optoelectronics Technology Co., ltd., Chongqing (CN)

(72) Inventor: EN-Tsung CHO, Chongqing (CN)

(21) Appl. No.: 16/349,991

(22) PCT Filed: Jun. 25, 2018
(86) PCT No.: PCT/CN2018/092597

§ 371 Date: May 15, 2019

(30) Foreign Application Priority Data
Feb. 5, 2018 (CN) 201810115563.3

(51) Int. Cl. G02F 1/13357; G02F 1/1368; G02F 1/133

(52) U.S. Cl. CPC G02F 1/13362; G02F 1/1368; G02F 2202/36; G02F 1/133621; G02F 2001/133614; G02F 1/13318

(57) ABSTRACT

The present application discloses a display device, including a first substrate, provided with a plurality of active switches thereon; a second substrate, disposed opposite to the first substrate, where a plurality of liquid crystal molecules are disposed between the second substrate and the first substrate; and a control component, including a backlight module, where the backlight module is disposed on one side of the first substrate away from the second substrate, and the backlight module includes a quantum dot film.

### TECHNICAL FIELD

The present application relates to the technical field of display, and in particular, to a display device.

### BACKGROUND

The existing displays are generally controlled based on active switches, have many advantages such as thin bodies, power saving and no radiation, have been widely used, and mainly include liquid crystal displays, organic light-emitting diode (OLED) displays, quantum dot light-emitting diode (QLED) displays, plasma displays, etc. There are flat displays and curved displays according to the appearance and structure.

The liquid crystal display includes a liquid crystal panel and a backlight module. The working principle of the liquid crystal display is to place liquid crystal molecules between two parallel glass substrates and apply a driving voltage to the two glass substrates to control a rotary direction of the liquid crystal molecules, so that the light of the backlight module is refracted to generate a picture.

The OLED display adopts organic light-emitting diodes to emit light for display, and has the advantages such as self-light emitting, a wide viewing angle, an almost infinitely high contrast, low power consumption, and an extremely high reaction speed.

The structure of the QLED display is very similar to that of the OLED technology. The main difference is that the light-emitting center of the QLED is composed of quantum dots. Its structure is that electrons and holes in both sides converge in a quantum dot layer to form photons (exciton), and light emission is realized by photon recombination.

However, with the gradual development of the liquid crystal display (LCD) products, how to cause the LCDs to have more excellent performances has become the direction of thinking and improvement by people. An example is to cause the LCD products to automatically adjust the display according to external instructions. It should be noted that the above description of the technical background is only for the purpose of a clear and complete explanation of the technical solutions of the present application, and is set forth for convenient understanding by a person skilled in the art. The above technical solutions are not considered to be known to a person skilled in the art although these solutions are set forth in the background section of the present application.

### SUMMARY

An objective of the present application is to provide a display device which can automatically adjust the display according to an indication of a user and is convenient to use.

In order to solve the above problem, the present application provides a display device.

The display device includes:

a first substrate, provided with a plurality of active switches thereon:

a second substrate, disposed opposite to the first substrate, where a plurality of liquid crystal molecules are disposed between the second substrate and the first substrate; and

a control component, including a backlight module, where the backlight module is disposed on one side of the first substrate away from the second substrate, and the backlight module includes a quantum dot film.

The backlight module includes a polarizing plate, the quantum dot film, and a blue light-emitting diode which are arranged in sequence, the blue light-emitting diode is disposed at one end away from the first substrate, and the polarizing plate is disposed at one end close to the first substrate, which is a specific arrangement of the backlight module on the outer side of the display panel.

Optionally, the backlight module includes the quantum dot film, a polarizing plate, and a blue light-emitting diode which are arranged in sequence, the blue light-emitting diode is disposed at one end away from the first substrate, and the quantum dot film is disposed at one end close to the first substrate, which is another specific arrangement of the backlight module on the outer side of the display panel.

Optionally, the first substrate is further provided with a plurality of pixels thereon, the pixels are coupled to the active switches, the pixels include light sensing elements, and the light sensing elements are PIN type photodiodes. The PIN type photodiode includes a P-type semiconductor layer, an intrinsic semiconductor layer, and an N-type semiconductor layer which are sequentially arranged from a direction of the first substrate.

Optionally, the quantum dot film includes a mesoporous framework, the mesoporous framework is a self-assembled mesoporous silica framework, the mesoporous framework is provided with holes therein, and quantum dots are disposed in the holes. By disposing the quantum dots in the mesoporous framework, and adjusting and controlling the sizes and the arrangement uniformity of the quantum dots, the light-emitting diodes with different light-emitting colors due to different sizes of the quantum dots can be adjusted, thereby realizing the adjustment and control uniformity of the light of different light-emitting colors in the active light-emitting display panel, and improving the display taste and the visual experience of the user. The mesoporous framework is of a specific silica framework structure, and the structure of the holes is adopted to facilitate the implementation of a self-assembled molecular template solution oxide. The molecular template has a good shaping effect, and the quantum dots are caused to be more evenly dispersed in gaps formed between the organic template and the inner walls of the holes. Hydroxyl groups are combined with the materials adopted by the quantum dots by van der Waals force to form the quantum dots in the mesoporous framework.

Optionally, diameters of the holes are 2-7 nm, which is the implementation of a specific setting of the hole size.

Optionally, at least two holes are disposed, and the at least two holes are unequal in diameter. Here, different holes are different in size, and the uniformity of a containing effect or containing velocity of the nanomaterials of different diameters can be achieved.

Optionally, the inner wall of the hole is a silica hole wall, and a thickness of the hole wall is 1-2 nm, which is a setting implementation manner of the material selection and the thickness of the hole wall.

Optionally, the quantum dots adopt III-V compound semiconductor nanomaterials, and the III-V compound semiconductor nanomaterials include gallium arsenide;

or the quantum dots adopt gallium nitride nanomaterials;

or the quantum dots adopt indium gallium zinc oxide nanomaterials;

or the quantum dots adopt silicon nanomaterials;

or the quantum dots adopt germanium nanomaterials;

where the quantum dots adopt any combination or any one of the above nanomaterials. The quantum dots adopt the III-V such as GaAs as well as GaN, Si, Ge, and SiGe, which is material selection of the quantum dots.

Optionally, the quantum dots adopt indium gallium zinc oxide nanomaterials, silicon nanomaterials, and germanium nanomaterials, which is specific material selection of the quantum dots.

According to another aspect of the present application, the present application further discloses a display device.

The display device includes:

a first substrate, provided with a plurality of active switches thereon:

a second substrate, disposed opposite to the first substrate, where a plurality of liquid crystal molecules are disposed between the second substrate and the first substrate; and

a control component, including a backlight module, where the backlight module is disposed on one side of the first substrate away from the second substrate, and the backlight module includes a quantum dot film;

where the backlight module includes a polarizing plate, the quantum dot film, and a blue light-emitting diode which are arranged in sequence, the blue light-emitting diode is disposed at one end away from the first substrate, and the polarizing plate is disposed at one end close to the first substrate;

where the quantum dot film includes a mesoporous framework, the mesoporous framework is a self-assembled mesoporous silica framework, the mesoporous framework is provided with holes therein, quantum dots are disposed in the holes, diameters of the holes are 2-7 nm, the inner wall of the hole is a silica hole wall, a thickness of the hole wall is 1-2 nm, and the quantum dots adopt indium gallium zinc oxide nanomaterials, silicon nanomaterials and germanium nanomaterials.

The present application utilizes the quantum dot film (QDs film) with spectral adjustability and environmental stability. The quantum dot film exists in the backlight module, and a layer of quantum dot film is added on the backlight of the display device. The quantum dot film can greatly improve the color reduction rate and overall brightness, thereby reducing the influence of ambient light on a light sensor, and improving the signal to noise (S/N). The quantum dot film is an optical film, and the optical materials adopting the quantum dots are placed between a backlight and the display panel, so that bright colors can be obtained by red, green, and blue light having sharp peak values.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a structural diagram of a display device according to an embodiment of the present application;

FIG. 2 is a schematic diagram of a display device according to an embodiment of the present application;

FIG. 3 is a schematic structural diagram of a mesoporous framework of a display panel according to an embodiment of the present application;

FIG. 4 is a schematic structural diagram of a mesoporous framework of a display panel according to an embodiment of the present application; and

FIG. 5 is a diagram of steps for forming a mesoporous material in a display panel according to an embodiment of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms “first”, “second” are merely for a descriptive purpose, and cannot to be understood to indicate or imply a relative importance, or implicitly indicate the number of the indicated technical features. Hence, the features defined by “first”, “second” can explicitly or implicitly include one or more of the features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or coupled; or directly connected or indirectly connected through an intermediate medium, or in an internal communication between two elements. The specific meanings about the foregoing terms in the present application may be understood for a person skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

In the drawings, the structurally similar elements are denoted with the same reference signs.

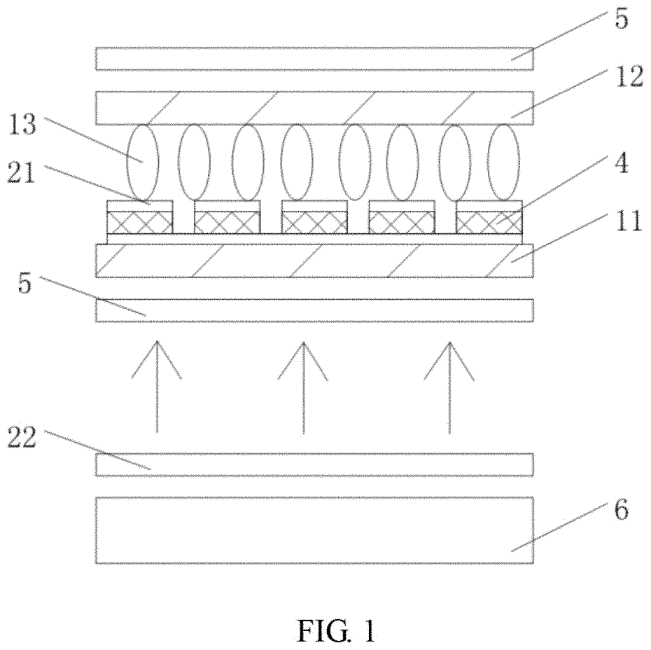

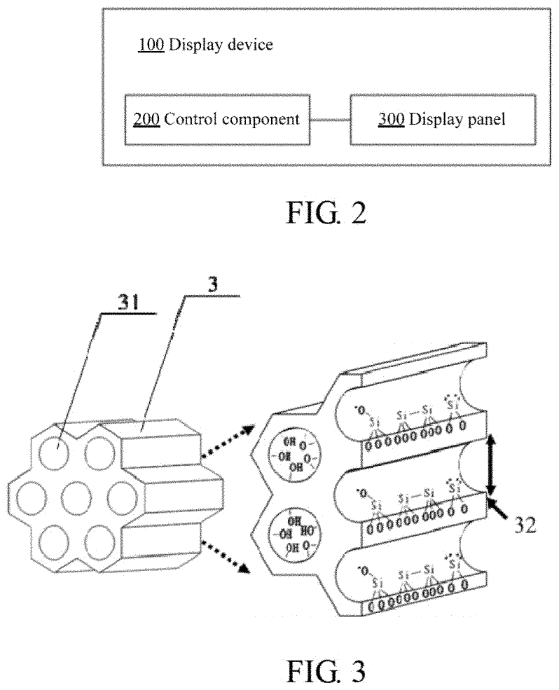

The display device of the present application will be described in further detail below with reference to the embodiments of FIGS. 1 to 5.

As an embodiment of the present application, as shown in FIGS. 1 to 5, the display device 100 includes a first substrate 11 on which a plurality of active switches are disposed; a second substrate 12, disposed opposite to the first substrate 11, where a plurality of liquid crystal molecules 13 are disposed between the second substrate 12 and the first substrate 11; and a control component 200, including a backlight module. The backlight module is disposed on one side of the first substrate 11 away from the second substrate 12, and the backlight module includes a quantum dot film 22. The quantum dot film (QDs film) 22 has spectral adjustability and environmental stability. The quantum dot film 22 exists in the backlight module, the layer of quantum dot film 22 is added on the backlight of the display device, and the quantum dot film 22 can greatly improve the color reduction rate and overall brightness, thereby reducing the influence of ambient light on a light sensor, and improving the signal to noise (S/N). The quantum dot film 22 is an optical film, and the optical materials adopting the quantum dots are placed between a backlight and the display panel, so that bright colors can be obtained by red, green, and blue light having sharp peak values.

As another embodiment of the present application, as shown in FIG. 1, the display device 100 includes a first substrate 11 on which a plurality of active switches are disposed; a second substrate 12, disposed opposite to the first substrate 11, where a plurality of liquid crystal molecules 13 are disposed between the second substrate 12 and the first substrate 11; and a control component 200, including a backlight module. The backlight module is disposed on one side of the first substrate 11 away from the second substrate 12, and the backlight module includes a quantum dot film 22. The backlight module includes a polarizing plate 5, the quantum dot film 22, and a blue light-emitting diode 6 which are arranged in sequence. The blue light-emitting diode 6 is disposed at one end away from the first substrate 11, and the polarizing plate 5 is disposed at one end close to the first substrate 11. Alternately, the backlight module includes the quantum dot film, a polarizing plate, and a blue light-emitting diode which are arranged in sequence, the blue light-emitting diode is disposed at one end away from the first substrate, and the quantum dot film is disposed at one end close to the first substrate. The quantum dot film (QDs film) 22 has spectral adjustability and environmental stability. The quantum dot film 22 exists in the backlight module, the layer of quantum dot film 22 is added on the backlight of the display device, and the quantum dot film 22 can greatly improve the color reduction rate and overall brightness, thereby reducing the influence of ambient light on a light sensor, and improving the signal to noise (S/N). The quantum dot film 22 is an optical film, and the optical materials adopting the quantum dots are placed between a backlight and the display panel, so that bright colors can be obtained by red, green, and blue light having sharp peak values.

As another embodiment of the present application, as shown in FIG. 1, the display device 100 includes a first substrate 11 on which a plurality of active switches are disposed; a second substrate 12, disposed opposite to the first substrate 11, where a plurality of liquid crystal molecules 13 is disposed between the second substrate 12 and the first substrate 11; and a control component 200, including a backlight module. The backlight module is disposed on one side of the first substrate 11 away from the second substrate 12, and the backlight module includes a quantum dot film 22. The backlight module includes a polarizing plate 5, the quantum dot film 22, and a blue light-emitting diode 6 which are arranged in sequence. The blue light-emitting diode 6 is disposed at one end away from the first substrate 11, and the polarizing plate 5 is disposed at one end close to the first substrate 11. In the display panel 300 (the display panel 300 includes an organic light-emitting diode (OLED) panel, a quantum dot light-emitting diode (QLED) panel or the like), the first substrate 11 is also provided with a plurality of pixels 21 thereon, and the pixels 21 are coupled to the active switches. The pixel 21 includes a light sensing element 4, and the light sensing element 4 is a PIN type photodiode. The PIN type photodiode includes a P-type semiconductor layer, an intrinsic semiconductor layer, and an N-type semiconductor layer which are sequentially arranged from a direction of the first substrate. The quantum dot film (QDs film) 22 has spectral adjustability and environmental stability. The quantum dot film 22 exists in the backlight module, the layer of quantum dot film 22 is added on the backlight of the display device, and the quantum dot film 22 can greatly improve the color reduction rate and overall brightness, thereby reducing the influence of ambient light on a light sensor, and improving the signal to noise (S/N). The quantum dot film 22 is an optical film, and the optical materials adopting the quantum dots are placed between a backlight and the display panel, so that bright colors can be obtained by red, green, and blue light having sharp peak values.

As another embodiment of the present application, as shown in FIGS. 1 and 3 to 5, the display device 100 includes a first substrate 11 on which a plurality of active switches are disposed; a second substrate 12, disposed opposite to the first substrate 11, where a plurality of liquid crystal molecules 13 is disposed between the second substrate 12 and the first substrate 11; and a control component 200, including a backlight module. The backlight module is disposed on one side of the first substrate 11 away from the second substrate 12, and the backlight module includes a quantum dot film 22. The backlight module includes a polarizing plate 5, the quantum dot film 22, and a blue light-emitting diode 6 which are arranged in sequence. The blue light-emitting diode 6 is disposed at one end away from the first substrate 11, and the polarizing plate 5 is disposed at one end close to the first substrate 11. The quantum dot film (QDs film) 22 has spectral adjustability and environmental stability. The quantum dot film 22 exists in the backlight module, the layer of quantum dot film 22 is added on the backlight of the display device, and the quantum dot film 22 can greatly improve the color reduction rate and overall brightness, thereby reducing the influence of ambient light on a light sensor, and improving the signal to noise (S/N). The quantum dot film 22 is an optical film, and the optical materials adopting the quantum dots are placed between a backlight and the display panel, so that bright colors can be obtained by red, green, and blue light having sharp peak values.

Specifically, as shown in FIG. 3, the quantum dot film 22 includes a mesoporous framework 3, the mesoporous framework 3 is a self-assembled mesoporous silica framework, and the mesoporous framework 3 is provided with holes 31 therein. The quantum dots are disposed in the holes 31. By disposing the quantum dots in the mesoporous framework 3, and adjusting and controlling the sizes and the arrangement uniformity of the quantum dots, the light-emitting diodes with different light-emitting colors due to different sizes of the quantum dots can be adjusted, thereby realizing the adjustment and control uniformity of the light of different light-emitting colors in the active light-emitting display panel 300, and improving the display taste and the visual experience of the user. The structure of the holes 31 is adopted to facilitate the implementation of a self-assembled molecular template solution oxide. The molecular template has a good shaping effect, and the quantum dots are caused to be more evenly dispersed in gaps formed between the organic template and the inner walls of the holes 31. Hydroxyl groups are combined with the materials adopted by the quantum dots by van der Waals force to form the quantum dots in the mesoporous framework 3.

Diameters of the holes are 2-7 nm, at least two holes are disposed, and the at least two holes are unequal in diameter. Different holes are different in size, and the uniformity of a containing effect or containing velocity of the nanomaterials of different diameters can be achieved. Exemplarily, the holes of three different diameters are disposed, the diameter of the first holes is 3 nanometers, the diameter of the second holes is 3.5 nanometers, and the diameter of the third holes is 5 nanometers, etc. Optionally, all holes may be set to have different diameters, thereby achieving the better containing effect or containing velocity uniformity of the nanomaterials. The inner wall of the hole 31 is a silica hole wall, and the thickness of the hole wall is 1-2 nm.

The organic template adopts III-V compound semiconductor materials, the II-V compound semiconductor materials include gallium arsenide; or the organic template adopts gallium nitride; or the organic template adopts silicon; or the organic template adopts germanium; or the organic template adopts silicon germanium. The organic template adopts any combination of the above materials or any one of the above materials.

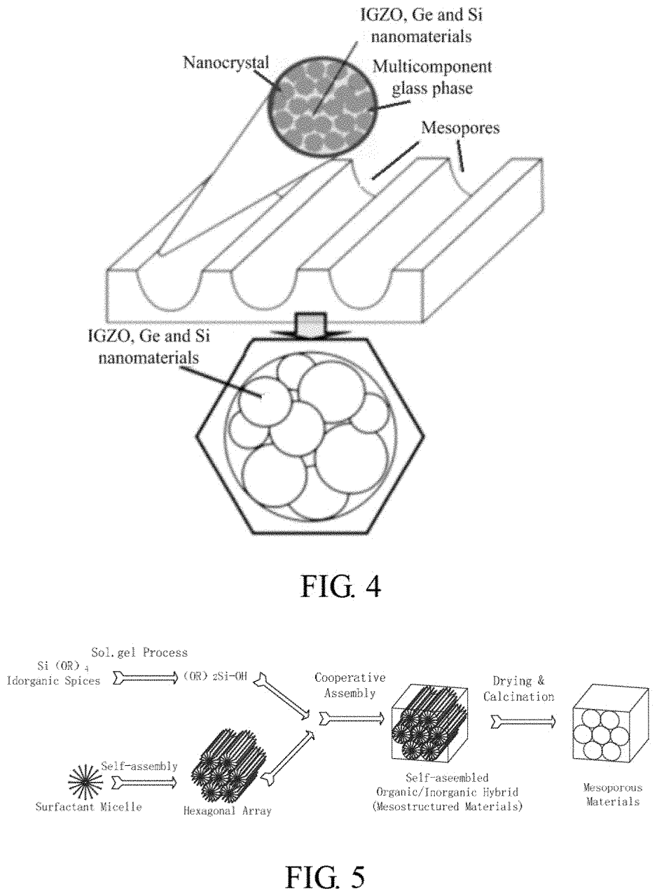

The quantum dots adopt III-V compound semiconductor nanomaterials, the III-V compound semiconductor nanomaterials include gallium arsenide nanomaterials; or the quantum dots adopt gallium nitride nanomaterials; or the quantum dots adopt indium gallium zinc oxide nanomaterials; or the quantum dots adopt silicon nanomaterials; or the quantum dots adopt germanium nanomaterials. The quantum dots adopt any combination of the above nanomaterials or any one of the above nanomaterials. Specifically, as shown in FIG. 4, the quantum dots adopt the indium gallium zinc oxide nanomaterials, the silicon nanomaterials, and the germanium nanomaterials. The radius of the quantum dot is less than or equal to an exciton Bohr radius. Since the radius is less than or equal to the exciton Bohr radius of the material, the quantum dots have a very significant quantum confinement effect. In the quantum dots with relatively small physical sizes, since the movement of carriers in all directions is limited, the original continuous energy band structure will become a quasi-discrete energy level, such that the effective band gap of the material will be increased and further the photons with higher energy and shorter wavelengths are radiated. It is not difficult to see that for the quantum dots of the same material, with the continuous reduction of the physical size, the emission spectrum can realize the transition from red light to blue light, thereby creating the most striking feature of the quantum dots, i.e., spectrum adjustability. In addition, the quantum dots have a relatively narrow half-peak width of the emission spectrum and better color purity and color saturation. Besides, the quantum dots are inorganic semiconductor materials with the environmental stability that cannot be achieved by organic chromophores. The quantum dots adopt the III-V such as GaAs as well as GaN, Si, Ge, and SiGe as an object. The hydroxyl (—OH) function groups are converted into the mesoporous silica framework on the surfaces of the holes 31.

As shown in FIG. 5, inorganic spices Si(OR)4 are converted into Si(OR)3Si—OH by a sol-gel process. The surfactant micelles are arranged into a hexagonal micelle rod by a self-assembly technology. The hexagonal micelle rod and Si(OR)3Si—OH are self-assembled by a cooperative assembly technology to form an organic/inorganic hybrid mesostructured material, which is then subjected to drying and calcination to form the mesoporous material.

The foregoing is further detailed explanation of the present application in conjunction with the specific embodiments, and it cannot be assumed that the specific implementation of the present application is limited to the explanation. For a person of ordinary skill in the art, several simple derivations and substitutions may be made without departing from the conception of the present application, and should be within the protective scope of the present application.

What is claimed is:

1. A display device, comprising:
a first substrate, provided with a plurality of active switches thereon;
a second substrate, disposed opposite to the first substrate, wherein a plurality of liquid crystal molecules are disposed between the second substrate and the first substrate; and
a control component, comprising a backlight module, wherein the backlight module is disposed on one side of the first substrate away from the second substrate, and the backlight module comprises a quantum dot film.

2. The display device according to claim 1, wherein the first substrate is further provided with a plurality of pixels thereon, the pixels are coupled to the active switches, the pixels comprise light sensing elements, and the light sensing elements are PIN type photodiodes.

3. The display device according to claim 1, wherein the backlight module comprises a polarizing plate, the quantum dot film, and a blue light-emitting diode which are arranged in sequence, the blue light-emitting diode is disposed at one end away from the first substrate, and the polarizing plate is disposed at one end close to the first substrate.

4. The display device according to claim 2, wherein the first substrate is further provided with a plurality of pixels thereon, the pixels are coupled to the active switches, the pixels comprise light sensing elements, and the light sensing elements are PIN type photodiodes.

5. The display device according to claim 1, wherein the backlight module comprises the quantum dot film, a polarizing plate, and a blue light-emitting diode which are arranged in sequence, the blue light-emitting diode is disposed at one end away from the first substrate, and the quantum dot film is disposed at one end close to the first substrate.

6. The display device according to claim 5, wherein the first substrate is further provided with a plurality of pixels thereon, the pixels are coupled to the active switches, the pixels comprise light sensing elements, and the light sensing elements are PIN type photodiodes.

7. The display device according to claim 5, wherein the PIN type photodiode comprises a P-type semiconductor layer, an intrinsic semiconductor layer, and an N-type semiconductor layer which are sequentially arranged from a direction of the first substrate.

8. The display device according to claim 1, wherein the quantum dot film comprises a mesoporous framework, the mesoporous framework is a self-assembled mesoporous silica frame, the mesoporous framework is provided with holes therein, and quantum dots are disposed in the holes.

9. The display device according to claim 8, wherein diameters of the holes are 2-7 nm.

10. The display device according to claim 8, wherein at least two holes are disposed, and the at least two holes are unequal in diameter.

11. The display device according to claim 8, wherein the inner wall of the hole is a silica hole wall.

12. The display device according to claim 10, wherein a thickness of the silica hole wall is 1-2 nm.

13. The display device according to claim 8, wherein the radius of the quantum dot are less than or equal to an exciton Bohr radius.

14. The display device according to claim 8, wherein optical materials of the quantum dots are disposed between a backlight of the backlight module and the display panel.

15. The display device according to claim 8, wherein the quantum dots are uniformly dispersed in gaps disposed between the inner walls of the holes.

16. The display device according to claim 8, wherein the quantum dots adopt III-V compound semiconductor nanomaterials.

17. The display device according to claim 16, wherein the III-V compound semiconductor nanomaterials comprise gallium arsenide nanomaterials, gallium nitride nanomaterials, indium gallium zinc oxide nanomaterials, silicon nanomaterials and germanium nanomaterials;
wherein the quantum dots adopt a combination of any above multiple nanomaterials.

18. The display device according to claim 17, wherein the quantum dots adopt the indium gallium zinc oxide nanomaterials, the silicon nanomaterials, and the germanium nanomaterials.

19. The display device according to claim 16, wherein the III-V compound semiconductor nanomaterials comprise gallium arsenide nanomaterials, gallium nitride nanomaterials, indium gallium zinc oxide nanomaterials, silicon nanomaterials, and germanium nanomaterials;
wherein the quantum dots adopt a combination of any above multiple nanomaterials.

20. A display device, comprising:
a first substrate, provided with a plurality of active switches thereon;
a second substrate, disposed opposite to the first substrate, wherein a plurality of liquid crystal molecules are disposed between the second substrate and the first substrate; and
a control component, comprising a backlight module, wherein the backlight module is disposed on one side of the first substrate away from the second substrate, and the backlight module comprises a quantum dot film;
wherein the backlight module comprises a polarizing plate, the quantum dot film, and a blue light-emitting diode which are arranged in sequence, the blue light-emitting diode is disposed at one end away from the first substrate, and the polarizing plate is disposed at one end close to the first substrate;
wherein the quantum dot film comprises a mesoporous framework, the mesoporous framework is a self-assembled mesoporous silica framework, the mesoporous framework is provided with holes therein, quantum dots are disposed in the holes, diameters of the holes are 2-7 nm, the inner wall of the hole is a silica hole wall, a thickness of the silica hole wall is 1-2 nm, and the quantum dots adopt indium gallium zinc oxide nanomaterials, silicon nanomaterials and/or germanium nanomaterials.
